(19) United States
(12) Patent Application Publication
(10) Pub. No.: US 2014/0304341 A1
(43) Pub. Date: Oct. 9, 2014

(54) MESSAGE REPORTING SYSTEM FOR VICTIMS OF BULLYING

(71) Applicant: Ming-Wei HSU, Taipei City (TW)

(72) Inventor: Ming-Wei HSU, Taipei City (TW)

(21) Appl. No.: 13/859,080

(22) Filed: Apr. 9, 2013

(51) Int. Cl. H04L 12/58

(52) U.S. Cl. CPC H04L 51/00
USPC 709/206

(57) ABSTRACT

The message reporting system has a receiver module, a processing module, a message type setting module, and at least one sending module. The receiver module receives an SOS message from at least one victim and the SOS message contains contact information of a bully. The processing module is connected to the receiver module and produces a reporting message in accordance with the SOS message, and then sets the bully in the contact information of the bully as a receiver of the reporting message. The message type setting module is connected to the processing module and is used for setting a type of the reporting message. The at least one sending module is connected to the processing module and is used for sending the reporting message to the bully.

### BACKGROUND OF THE INVENTION

1. Field of the invention

The present invention relates to a message reporting system and more particularly to a message reporting system for victims of bullying.

2. Description of Related Art

Bullying has long existed on campus or at workplace. Bullying means that a bully maliciously attacks a victim by physical assault on the body or by verbal harassment or any other harassment that mentally poses threat. Such abusing behavior must be stopped immediately to prevent the abusing behavior from occurring again. In general, the victim is weaker in either social or physical power than the bully, such that the victim is afraid to or can hardly defend himself/herself. The bully may be an individual or even a group of people. The victim is oppressed and feels anger, pain, shame, embarrassment, fear and depression under the threat of bullying.

Though bullying tremendously hurts the victims, most bullying cases are still under cover. In addition that the victim is afraid to reveal the bullying under threat from the bully, people who are concerned with but deliberately conceal the bullying become the biggest accomplice of the bullying. For example, when a student is bullied on campus, teachers and school executives may ignore the bullying to maintain a school's reputation. Therefore, the bullying becomes even worse as the bully turns more forceful and the victim is further isolated into fear and silence, such that bullying never stops and a damage done to the victim becomes deeper.

As shown from the above description, the bullying is usually hidden under cover intentionally or unintentionally. The bully becomes more forceful and the victim is more afraid so that the bullying keeps happening. For the above-mentioned situation, an effective way for solving the bullying must be combined with technology.

### SUMMARY OF THE INVENTION

The main objective of the invention is to provide a message reporting system for victims of bullying. A victim reports a bullying to the message reporting system. The message reporting system plays a role of a third-party and notifies the bully that the bullying has been reported. If the bully keeps bullying the victim, a message is sent to the bully to warn the bully that there will be a counter-measure to stop the bullying. By the above operation, the victim is protected effectively by the message reporting system.

The message reporting system comprises a receiver module, a processing module, a message type setting module, and at least one sending module. The receiver module is used for receiving an SOS message from at least one victim and the SOS message contains contact information of a bully. The processing module is connected to the receiver module and produces a reporting message in accordance with the SOS message, and then sets the bully in the contact information of the bully as a receiver of the reporting message. The message type setting module is connected to the processing module and is used for setting a type of the reporting message. The at least one sending module is connected to the processing module and is used for sending the reporting message to the bully.

The message reporting system receives the SOS message from the at least one victim by the receiver module. The processing module produces the reporting message in accordance with the SOS message and the message type setting module sets a type of the reporting message as “a warning”, “disclosure to media” or “legal avenues” and then the reporting message is sent to the bully through the contact information of the bully (name, e-mail address, cell phone number, a social communication networking account, etc) in the SOS message by a corresponding sending module. The message reporting system plays a role of a third-party so that the bully knows that the bullying has been made public and there will be a counter-measure. Therefore, the message reporting system stops continuation of bullying and protects the victim effectively.

### BRIEF DESCRIPTION OF THE DRAWINGS

FIG. 1 is a block diagram of a first embodiment of a message reporting system in accordance with the present invention;

FIG. 2 is a block diagram of a second embodiment of a message reporting system in accordance with the present invention; and

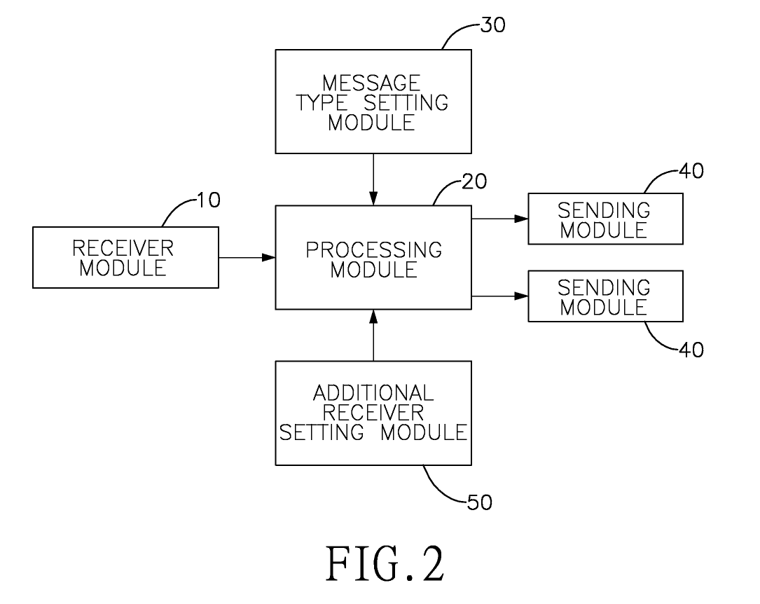

FIG. 3 is an operational diagram of the present invention, showing the second embodiment of message reporting system in accordance with the present invention working.

### DETAILED DESCRIPTION OF THE PREFERRED EMBODIMENTS

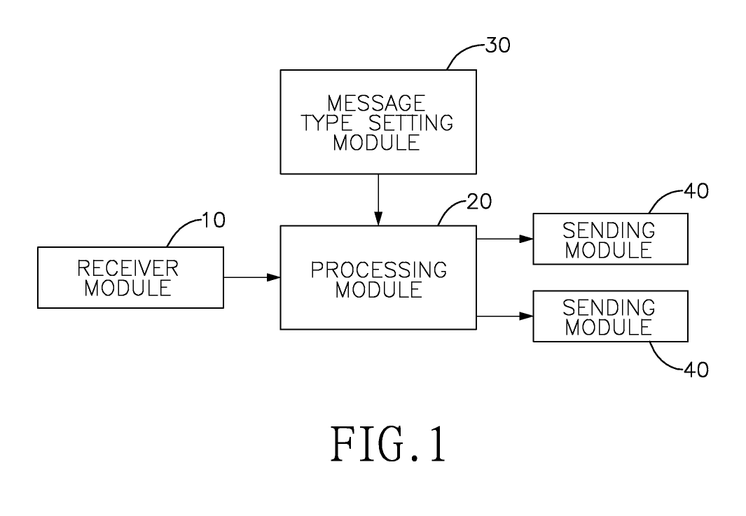

In a preferred embodiment as shown in FIG. 1, a message reporting system includes a receiver module 10, a processing module 20, a message type setting module 30 and at least one sending module 40.

The receiver module 10 receives an SOS message from at least one victim. When the present invention is built in a website or a web page, the receiver module 10 can be a mail responding system or a message responding system, that is, the at least one victim can use an e-mail to send the SOS message, and the processing system of the message reporting system acts as a receiver of the victim's e-mail.

The processing module 20 is connected to the receiver module 10 and produces a reporting message in accordance with the SOS message. The processing module 20 can retrieve contact information of a bully from the SOS message and set the bully as a receiver of the reporting message. The processing module 20 can also provide a victim message form from the SOS message to guide the victim to input the contact information of the bully. The contact information of the bully includes e-mail address, cell phone number, a social communication networking account (SKYPE, LINE, WHAT'S APP, WECHAT, QQ, FaceBook, Google+, MSN, GTALK, M+messenger, plurk, Twitter, etc).

The message type setting module 30 is connected to the processing module 20 and is used for setting a type of the reporting message. The receiver of the reporting message is the bully, and a content of the reporting message should correspond to a threatening level of the bullying. In the preferred embodiment, the message type setting module 30 provides three types of the reporting messages: “a warning”, “disclosure to media” and “legal avenues”. When the bullying is minor in degree of threat, the victim can set the type of the reporting message as “a warning”, that is, the reporting message just notifies the bully that the bullying action has been reported and any subsequent situation is under monitoring. When the bullying becomes worse, the victim can set the type of the reporting message as “disclosure to media”. The victim can strongly warn the bully by media. When the bullying enforces any personal assault on the victim, the victim can set the type of the reporting message as “legal avenues” to notify the bully that the victim will resolve the bullying through legal avenues. The “legal avenues” includes “legal attest letters” and “litigation”.

After the processing module 20 produces the reporting message and the message type setting module 30 sets the type of the reporting message, the sending module 40 sends the reporting message to the bully. The sending module 40 is connected to different severs and sends the reporting message to the bully in different formats (MAIL, SMS, MMS) through the contact information of the bully provided by the victim.

In order to increase a protective effect to the victim, the message reporting system further includes an additional receiver setting module 50 for the victim to set (by either inputting or menu-selection) an additional person or agency to report the bullying besides the bully. The additional person or the agency can be a teacher, a dean of students, a principal, the media, a law firm, a police agency, etc.

In conclusion, the main objective of the invention is to provide a message reporting system for victims of bullying or domestic violence to call for help. For example, when a bullying occurs on campus, student A heads student B and student C to extort student D by violence of peer bullying. After the student D reports the bullying, the teacher and the school executives still ignore the bullying such that the student D is afraid to go to school and is continuously bullied.

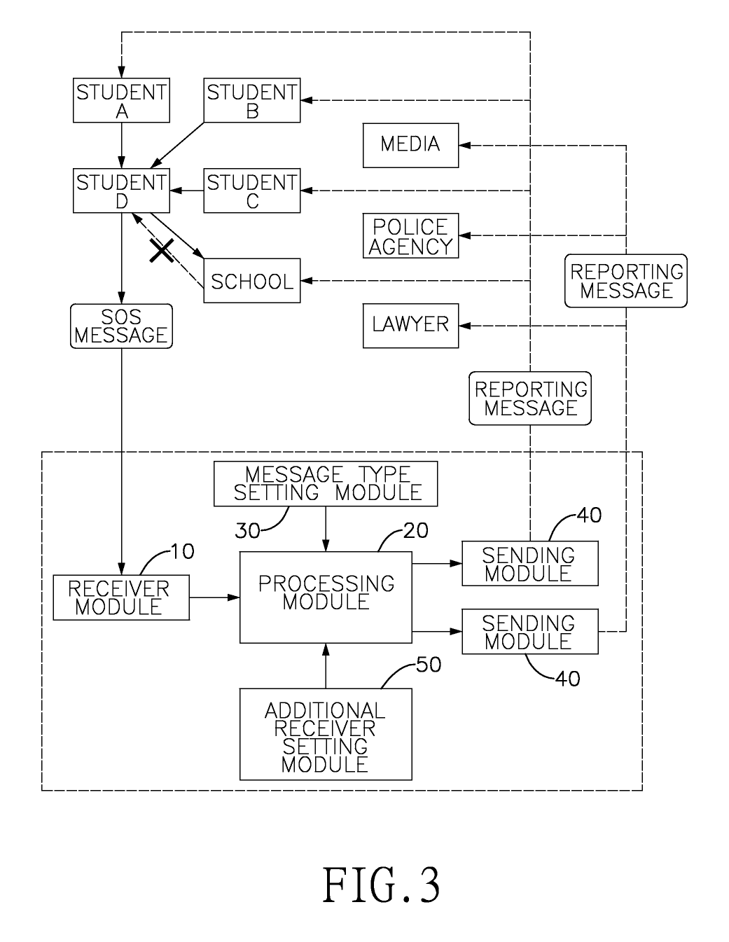

In the above-mentioned situation, the student D can send an SOS message to the message reporting system in accordance with the present invention as shown in FIG. 3. The receiver module 10 receives the SOS message and sends the SOS message to the processing module 20. The processing module 20 produces a reporting message and retrieves contact information of a bully from the SOS message or guides the victim to provide the contact information of the bully, and then finds the receiver of the reporting message through the contact information of the bully. The sending module 40 sends the reporting message to the bully. A type of the reporting message is set by the message type setting module 30 and the type can be “a warning”, “disclosure to media” or “legal avenues” depending on a severity of the bullying to warn the bully strongly.

In addition, in a preferred embodiment of a message reporting system in accordance with the present invention further includes a function of reporting to an additional person or agency. Therefore, the victim can stop the bullying by disclosure to media or execution of public power. The message reporting system further comprises an additional receiver setting module 50 for the victim to set up other additional individuals or agencies such as a teacher, a principal, media, a lawyer or a police agency as a receiver besides the bully. Because the message reporting system plays a role as the third-party and sends the reporting message, for the receivers like teacher or principal, the bullying has been made public and cannot be covered anymore so that the teacher or the principal is urged to handle the bullying positively. For the receiver like media, the bullying is revealed and raises a public concern to put pressure on the bully or other people concerned and to stop the bullying strongly. When the bully causes a serious personal injury to the victim, the victim can go through legal avenues to seek remedies.

In conclusion, the message reporting system plays a role of a third-party and sends the reporting message to the bully so that the bully knows that the bullying has been made public and the victim will have necessary counter-measure to stop the bullying effectively and protect the victim.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A message reporting system for victims of bullying comprising:
a receiver module for receiving an SOS message from at least one victim, wherein the SOS message contains contact information of a bully;
a processing module connected to the receiver module and producing a reporting message in accordance with the SOS message, and setting the bully in the contact information as a receiver of the reporting message;
a message type setting module connected to the processing module and used for setting a type of the reporting message; and
at least one sending module connected to the processing module and sending the reporting message to the bully.

2. The message reporting system as claimed in claim 1, wherein the type of the reporting message includes “a warning”.

3. The message reporting system as claimed in claim 1, wherein the type of the reporting message includes “disclosure to media”.

4. The message reporting system as claimed in claim 1, wherein the type of the reporting message includes “legal avenues”.

5. The message reporting system as claimed in claim 2, wherein the contact information of the bully includes an e-mail address, a cell phone number, or a social communication networking account.

6. The message reporting system as claimed in claim 3, wherein the contact information of the bully includes an e-mail address, a cell phone number, or a social communication networking account.

7. The message reporting system as claimed in claim 4, wherein the contact information of the bully includes an e-mail address, a cell phone number, or a social communication networking account.

8. The message reporting system as claimed in claim 1, wherein the message reporting system further comprises an additional receiver setting module for setting an additional party who receives the reporting message.

9. The message reporting system as claimed in claim 5, wherein the message reporting system further comprises an additional receiver setting module for setting an additional party who receives the reporting message.

10. The message reporting system as claimed in claim 6, wherein the message reporting system further comprises an additional receiver setting module for setting an additional party who receives the reporting message.

11. The message reporting system as claimed in claim 7, wherein the message reporting system further comprises an additional receiver setting module for setting an additional party who receives the reporting message.

12. The message reporting system as claimed in claim 5, wherein the social communication networking account is a SKYPE account, a LINE account, a WHAT'S APP account, a WECHAT account, a QQ account, a FaceBook account, a Google+ account, an MSN account, a GTALK account, an M+messenger account, a plurk account, or a Twitter account.

13. The message reporting system as claimed in claim 6, wherein the social communication networking account is a SKYPE account, a LINE account, a WHAT'S APP account, a WECHAT account, a QQ account, a FaceBook account, a Google+ account, an MSN account, a GTALK account, an M+messenger account, a plurk account, or a Twitter account.

14. The message reporting system as claimed in claim 7, wherein the social communication networking account is a SKYPE account, a LINE account, a WHAT'S APP account, a WECHAT account, a QQ account, a FaceBook account, a Google+ account, an MSN account, a GTALK account, an M+messenger account, a plurk account, or a Twitter account.

15. The message reporting system as claimed in claim 1, wherein the sending module sends the reporting message in MAIL format.

16. The message reporting system as claimed in claim 1, wherein the sending module sends the reporting message in SMS format.

17. The message reporting system as claimed in claim 1, wherein the SOS message is in text form.

18. The message reporting system as claimed in claim 1, wherein the SOS message is in voice form.

19. The message reporting system as claimed in claim 1, wherein the reporting message is in text form.

20. The message reporting system as claimed in claim 1, wherein the reporting message is in voice form.
